(19) United States
(12) Patent Application Publication
(10) Pub. No.: US 2016/0149492 A1
(43) Pub. Date: May 26, 2016

(54) VOLTAGE ADJUSTING APPARATUS

(71) Applicants: HONG FU JIN PRECISION INDUSTRY (WuHan) CO., LTD., Wuhan (CN); HON HAI PRECISION INDUSTRY CO., LTD., New Taipei (TW)

(72) Inventors: TONG-QI HUANG, Wuhan (CN); CHUN-SHENG CHEN, New Taipei (TW)

(21) Appl. No.: 14/683,719

(22) Filed: Apr. 10, 2015

(30) Foreign Application Priority Data
Nov. 24, 2014 (CN) 201410678748.7

(51) Int. Cl. H02M 3/158

(52) U.S. Cl. CPC H02M 3/158

(57) ABSTRACT

A voltage adjusting apparatus for an electronic device includes an input output control unit, a voltage dividing module, a switching module, and a voltage converting unit. The input output control unit outputs different voltage level control signals according to power requirements of the electronic device. The voltage dividing module includes at least a first resistor and a second resistor. The switching module receives the control signals, and selectively connects the at least first resistor or the second resistor in the voltage dividing module according to the different voltage level control signals. The voltage converting unit receives a first direct current (DC) voltage, and converts the first DC voltage to a feedback voltage. The voltage converting unit outputs a working voltage to the electronic device according to the feedback voltage and the at least first resistor or the second resistor connected in the voltage dividing module.

### CROSS-REFERENCE TO RELATED APPLICATIONS

This application claims priority to Chinese Patent Application No. 201410678748.7 filed on Nov. 24, 2014, the contents of which are incorporated by reference herein in its entirety.

### FIELD

The subject matter herein generally relates to a voltage adjusting apparatus.

### BACKGROUND

Printed circuit boards (PCBs) usually have slots for inserting memory chips. Power supplies provided to the memory chips include 1.5 volts, 1.35 volts, and 1.25 volts direct current (“DC”) voltages. A conventional PCB only provides a single DC voltage, which cannot meet the requirements when multiple memory chips are installed on the same PCB.

### BRIEF DESCRIPTION OF THE DRAWINGS

Implementations of the present technology will now be described, by way of example only, with reference to the attached figures.

FIG. 1 is a block diagram of an embodiment of a voltage adjusting apparatus.

FIG. 2 is a circuit diagram of the voltage adjusting apparatus of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising,” when utilized, means “including, but not necessarily limited to”; it specifically indicates open-ended inclusion or membership in the so-described combination, group, series and the like. “Unit” means a collection of electronic hardware alone or in combination with software configured for a particular task or function, although units may overlap or share components.

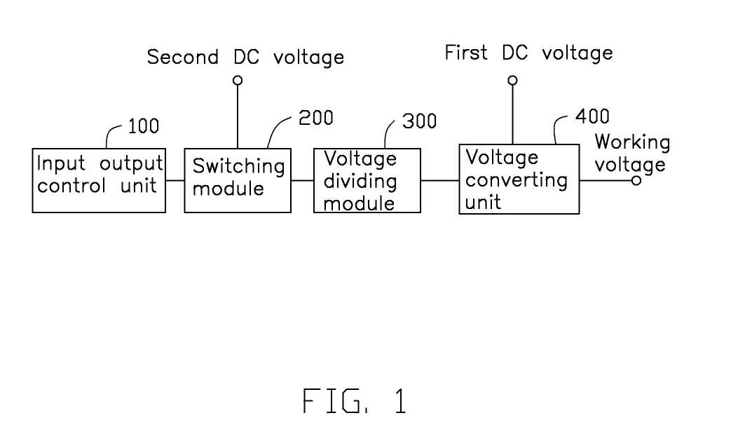

FIG. 1 illustrates a voltage adjusting apparatus in accordance with one embodiment. The voltage adjusting apparatus includes an input output control unit 100, a switching module 200, a voltage dividing module 300, and a voltage converting unit 400.

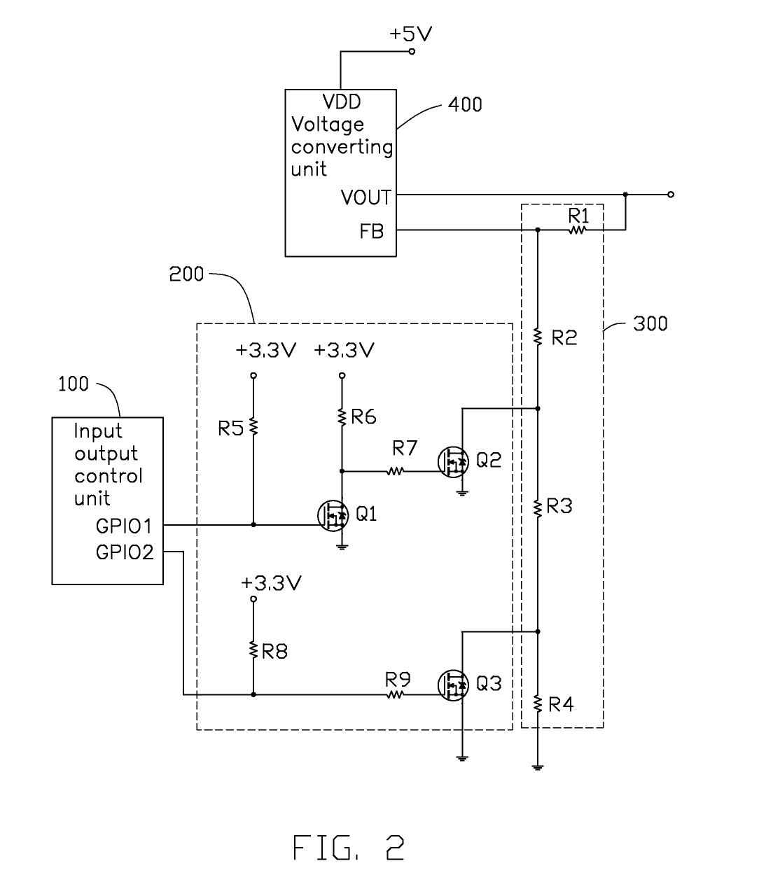

FIG. 2 illustrates that the input output control unit 100 includes a first general purpose input output (GPIO) port GPIO1 and a second GPIO port GPIO2. The switching module 200 includes a first switch Q1, a second switch Q2, a third switch Q3, a fifth resistor R5, a sixth resistor R6, a seventh resistor R7, an eighth resistor R8, and a ninth resistor R9. Each of the first switch Q1 , the second switch Q2, and the third switch Q3 includes a first terminal, a second terminal, and a third terminal. In at least one embodiment, the first switch Q1, the second switch Q2, and the third switch Q3 are n-channel MOSFETs. The first terminal, the second terminal, and the third terminal are gate, source, and drain respectively.

The first GPIO port GPIO1 is electrically coupled to the first terminal of the first switch Q1. The first terminal of the first switch Q1 is configured to receive a second direct current (DC) voltage via the fifth resistor R5. The second terminal of the first switch Q1 is grounded. The third terminal of the first switch Q1 is configured to receive the second DC voltage via the sixth resistor R6. The third terminal of the first switch Q1 is electrically coupled to the first terminal of the second switch Q2 via the seventh resistor R7. The second terminal of the second switch Q2 is grounded. The third terminal of the second switch Q2 is electrically coupled to the voltage dividing module 300.

The second GPIO port GPIO2 is configured to receive the second DC voltage via the eighth resistor R8. A connecting point between the second GPIO port GPIO2 and the eighth resistor R8 is electrically coupled to the first terminal of the third switch Q3 via the ninth resistor R9. The second terminal of the third switch Q3 is grounded. The third terminal of the third switch Q3 is electrically coupled to the voltage dividing module 300. In at least one embodiment, the second DC voltage is substantially +3.3 volts.

The voltage dividing module 300 includes a first resistor R1, a second resistor R2, a third resistor R3, and a fourth resistor R4. The voltage converting unit 400 includes a DC voltage input terminal VDD, a DC voltage output terminal VOUT, and a feedback terminal FB. The DC voltage input terminal VDD is configured to receive a first DC voltage. The DC voltage output terminal VOUT is electrically coupled to the feedback terminal FB via the first resistor R1. A connecting point between the feedback terminal FB and the first resistor R1 is electrically coupled to the third terminal of the second switch Q2 via the second resistor R2. A connecting point between the third terminal of the second switch Q2 and the second resistor R2 is electrically coupled to the third terminal of the third switch Q3 via the third resistor R3. A connecting point between the third terminal of the third switch Q3 and the third resistor R3 is grounded via the fourth resistor R4.

In at least one embodiment, a resistance of each of the first resistor R1 and the second resistor R2 is substantially 10 kilo-ohms. A resistance of each of the third resistor R3 and the fourth resistor R4 is substantially 2.49 kilo-ohms. The first DC voltage is substantially +5 volts.

In use, the first GPIO port GPIO1 and the second GPIO port GPIO2 of the input output control unit 100 output different voltage level control signals according to power requirements of an electronic device (not shown). The voltage converting unit 400 converts the +5 volts first DC voltage to a feedback voltage which is output by the feedback terminal FB. The DC voltage output terminal VOUT of the voltage converting unit 400 outputs the corresponding working voltage to the electronic device according to the resistor connected in the voltage dividing module 300. In at least one embodiment, the electronic device is a memory chip. The feedback voltage is +0.75 volts.

When the first GPIO port GPIO1 outputs a low voltage level control signal to the first terminal of the first switch Q1, the first switch Q1 turns off. The first terminal of the second switch Q2 receives the +3.3 volts second DC voltage. The second switch Q2 turns on. The first resistor R1 and the second resistor R2 are connected in the voltage dividing module 300 by the switching module 200. The working voltage Vout is calculated by the following formula:

Vout=Vfb×(r1+r2)/r2.

When the first GPIO port GPIO1 and the second GPIO port GPIO2 both output high voltage level control signals to the first terminals of the first switch Q1 and the third switch Q3 respectively, the first switch Q1 and the third switch Q3 both turn on. The first terminal of the second switch Q2 is grounded via the first switch Q1. The second switch Q2 turns off The first resistor R1, the second resistor R2, and the third resistor R3 are connected in the voltage dividing module 300 by the switching module 200. The working voltage Vout is calculated by the following formula:

Vout=Vfb×(r1+r2+r3)/(r2+r3).

When the first GPIO port GPIO1 outputs a high voltage level control signal to the first terminal of the first switch Q1 and the second GPIO port GPIO2 outputs a low voltage level control signal to the first terminal of the third switch Q3 respectively, the first switch Q1 turns on, the third switch Q3 turns off. The first terminal of the second switch Q2 is grounded via the first switch Q1. The second switch Q2 turns off The first resistor R1, the second resistor R2, the third resistor R3, and the fourth resistor R4 are connected in the voltage dividing module 300 by the switching module 200. The working voltage Vout is calculated by the following formula:

Vout=Vfb×(r1+r2+r3+r4)/(r2+r3+r4).

In the above formula, r1, r2, r3, and r4 represent resistances of the first resistor R1, the second resistor R2, the third resistor R3, and the fourth resistor R4 respectively. According to the above formula, the working voltage Vout is 1.5 volts if the first GPIO port GPIO1 outputs the low voltage level control signal, the working voltage Vout is 1.35 volts if the first GPIO port GPIO1 and the second GPIO port GPIO2 both output high voltage level control signals, and the working voltage Vout is 1.25 volts if the first GPIO port GPIO1 and the second GPIO port GPIO2 output the high voltage level control signal and the low voltage level control signal respectively.

In an original state, when the input output control unit 100 does not work, the first GPIO port GPIO1 and the second GPIO port GPIO2 cannot output the control signals. The first terminals of the first switch Q1 and the third switch Q3 receive the +3.3 volts second DC voltage. The first switch Q1 and the third switch Q3 both turn on. The working voltage Vout is 1.35 volts.

The embodiments shown and described above are only examples. Many details are often found in the art such as the other features of a voltage adjusting apparatus. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including the full extent established by the broad general meaning of the terms used in the claims. It will therefore be appreciated that the embodiments described above may be modified within the scope of the claims.

What is claimed is:

1. A voltage adjusting apparatus for an electronic device comprising:
an input output control unit configured to output different voltage level control signals according to power requirements of the electronic device;
a voltage dividing module comprising at least a first resistor and a second resistor;
a switching module configured to receive the control signals, and selectively connect the at least first resistor or the second resistor in the voltage dividing module according to the different voltage level control signals; and
a voltage converting unit configured to receive a first direct current (DC) voltage, and convert the first DC voltage to a feedback voltage;
wherein the voltage converting unit outputs a working voltage to the electronic device according to the feedback voltage and the at least first resistor or the second resistor connected in the voltage dividing module.

2. The voltage adjusting apparatus of claim 1, wherein the input output control unit comprises a first general purpose input output (GPIO) port and a second GPIO port; the switching module comprises a first switch, a second switch, and a third switch; each of the first switch, the second switch, and the third switch comprises a first terminal, a second terminal, and a third terminal;
the first GPIO port is electrically coupled to the first terminal of the first switch; the first terminal of the first switch is configured to receive a second DC voltage; the second terminal of the first switch is grounded; the third terminal of the first switch is configured to receive the second DC voltage; the third terminal of the first switch is electrically coupled to the first terminal of the second switch; the second terminal of the second switch is grounded; the third terminal of the second switch is electrically coupled to the voltage dividing module; the second GPIO port is electrically coupled to the first terminal of the third switch; the first terminal of the third switch is configured to receive the second DC voltage; and second terminal of the third switch is grounded; and the third terminal of the third switch is electrically coupled to the voltage dividing module.

3. The voltage adjusting apparatus of claim 2, wherein the voltage dividing module further comprises a third resistor and a fourth resistor; the voltage converting unit comprises a DC voltage input terminal, a DC voltage output terminal, and a feedback terminal; the DC voltage input terminal is configured to receive a first DC voltage; the DC voltage output terminal is electrically coupled to the feedback terminal via the first resistor; a connecting point between the feedback terminal and the first resistor is electrically coupled to the third terminal of the second switch via the second resistor; a connecting point between the third terminal of the second switch and the second resistor is electrically coupled to the third terminal of the third switch via the third resistor; and a connecting point between the third terminal of the third switch and the third resistor is grounded via the fourth resistor.

4. The voltage adjusting apparatus of claim 3, wherein a resistance of each of the first resistor and the second resistor is substantially 10 kilo-ohms; and a resistance of each of the third resistor and the fourth resistor is substantially 2.49 kilo-ohms.

5. The voltage adjusting apparatus of claim 3, wherein when the first GPIO port outputs a low voltage level control signal to the first terminal of the first switch, the first switch turns off, the second switch turns on, and the first resistor and the second resistor are connected in the voltage dividing module by the switching module.

6. The voltage adjusting apparatus of claim 3, wherein when the first GPIO port and the second GPIO port both output high voltage level control signals to the first terminals of the first switch and the third switch respectively, the first switch and the third switch both turn on, the second switch turns off, and the first resistor, the second resistor, and the third resistor are connected in the voltage dividing module by the switching module.

7. The voltage adjusting apparatus of claim 3, wherein when the first GPIO port outputs a high voltage level control signal to the first terminal of the first switch and the second GPIO port outputs a low voltage level control signal to the first terminal of the third switch respectively, the first switch turns on, the third switch turns off, the second switch turns off, and the first resistor, the second resistor, the third resistor, and the fourth resistor are connected in the voltage dividing module by the switching module.

8. The voltage adjusting apparatus of claim 2, wherein the first switch, the second switch, and the third switch are n-channel MOSFETs; and the first terminal, the second terminal, and the third terminal are gate, source, and drain respectively.

9. The voltage adjusting apparatus of claim 2, wherein the first DC voltage is substantially +5 volts; and the second DC voltage is substantially +3.3 volts.

10. A voltage adjusting apparatus for an electronic device comprising:
an input output control unit comprising a first general purpose input output (GPIO) port and a second GPIO port configured to output different voltage level control signals according to power requirements of the electronic device;
a voltage dividing module comprising a first resistor, a second resistor, a third resistor and a fourth resistor;
a switching module comprising a first switch, a second switch, and a third switch configured to receive the control signals, and selectively connect the first resistor, the second resistor, the third resistor, or the fourth resistor in the voltage dividing module according to the different voltage level control signals; and
a voltage converting unit configured to receive a first direct current (DC) voltage, and convert the first DC voltage to a feedback voltage;
wherein when the first GPIO port outputs a low voltage level control signal, the first switch turns off, the second switch turns on, and the first resistor and the second resistor are connected in the voltage dividing module by the switching module;
wherein when the first GPIO port and the second GPIO port both output high voltage level control signals, the first switch and the third switch both turn on, the second switch turns off, and the first resistor, the second resistor, and the third resistor are connected in the voltage dividing module by the switching module;
wherein when the first GPIO port outputs a high voltage level control signal and the second GPIO port outputs a low voltage level control signal, the first switch turns on, the third switch turns off, the second switch turns off, and the first resistor, the second resistor, the third resistor, and the fourth resistor are connected in the voltage dividing module by the switching module; and
wherein the voltage converting unit outputs a working voltage to the electronic device according to the feedback voltage and the first resistor, the second resistor, the third resistor, or the fourth resistor connected in the voltage dividing module.

11. The voltage adjusting apparatus of claim 10, wherein each of the first switch, the second switch, and the third switch comprises a first terminal, a second terminal, and a third terminal;
the first GPIO port is electrically coupled to the first terminal of the first switch; the first terminal of the first switch is configured to receive a second DC voltage; the second terminal of the first switch is grounded; the third terminal of the first switch is configured to receive the second DC voltage; the third terminal of the first switch is electrically coupled to the first terminal of the second switch; the second terminal of the second switch is grounded; the third terminal of the second switch is electrically coupled to the voltage dividing module; the second GPIO port is electrically coupled to the first terminal of the third switch; the first terminal of the third switch is configured to receive the second DC voltage; and second terminal of the third switch is grounded; and the third terminal of the third switch is electrically coupled to the voltage dividing module.

12. The voltage adjusting apparatus of claim 11, wherein the voltage converting unit comprises a DC voltage input terminal, a DC voltage output terminal, and a feedback terminal; the DC voltage input terminal is configured to receive a first DC voltage; the DC voltage output terminal is electrically coupled to the feedback terminal via the first resistor; a connecting point between the feedback terminal and the first resistor is electrically coupled to the third terminal of the second switch via the second resistor; a connecting point between the third terminal of the second switch and the second resistor is electrically coupled to the third terminal of the third switch via the third resistor; and a connecting point between the third terminal of the third switch and the third resistor is grounded via the fourth resistor.

13. The voltage adjusting apparatus of claim 12, wherein a resistance of each of the first resistor and the second resistor is substantially 10 kilo-ohms; and a resistance of each of the third resistor and the fourth resistor is substantially 2.49 kilo-ohms.

14. The voltage adjusting apparatus of claim 11, wherein the first switch, the second switch, and the third switch are n-channel MOSFETs; and the first terminal, the second terminal, and the third terminal are gate, source, and drain respectively.

15. The voltage adjusting apparatus of claim 11, wherein the first DC voltage is substantially +5 volts; and the second DC voltage is substantially +3.3 volts.

16. A voltage adjusting apparatus for an electronic device comprising:
an input/output control unit configured to output a control signal of at least a first voltage level and a second voltage level;
a voltage dividing module comprising a plurality of resistors;
a switching module configured to receive the control signal from the control unit and selectively connect two or more of the plurality of voltage module resistors; and
a voltage converting unit configured to receive a first direct current voltage and convert the first direct current voltage to a feedback voltage;
wherein, the two or more resistors connected by the switching module depend on the voltage level of the control signal received from the control unit; and
wherein, the voltage converting unit outputs a working voltage based on the feedback voltage and the resistors connected in the voltage dividing unit by the switching module.
